(19) United States
(12) Patent Application Publication
(10) Pub. No.: US 2007/0115675 A1
(43) Pub. Date: May 24, 2007

(54) Auxiliary lamp on side view mirror of vehicle

(76) Inventors: Chin-Lung Tsai, Taichung City (TW); Chun-Jung Liao, Taichung City (TW)

Correspondence Address: TROXELL LAW OFFICE PLLC;SUITE 1404, 5205 LEESBURG PIKE, FALLS CHURCH, VA, 22041, US

(21) Appl. No.: 11/284,828

(22) Filed: Nov. 23, 2005

(51) Int. Cl. B60Q 1/26

(52) U.S. Cl. 362/487

(57) ABSTRACT

An auxiliary lamp of a side view mirror 1 includes a light providing backup illumination on inner side and a multidirectional turn-signal lamp on outer side thereof, both on bottom area thereof. The multidirectional turn-signal lamp indicates three directions of turns-front side, rear side and lateral side. The light providing backup illumination only works when the car lights and the reversing lamps acts synchronously so that the light illuminates the rear wheels while revering at night. And the multi-directional turn-signal lamp works synchronously with original car turn-signal lamps so as to make the side view mirror has function of front-side, lateral-side and rear-side indications. Therefore, the safety and convenience of vehicles while turning at night are improved. The performance and the added value are also increased.

### BACKGROUND OF THE INVENTION

The present invention relates to an auxiliary lamp on a side view mirror for vehicles, especially to an auxiliary lamp disposed on bottom area of the side view mirror. The auxiliary lamp consists of a light providing backup illumination on inner side of the side view mirror and a multi-directional turn-signal lamp with function of front-side, lateral-side and rear-side indications. Thus the auxiliary lamp on side view mirror works as light providing backup illumination and multifunction indicator lamp.

A side view mirror having a housing and a mirror is disposed on two sides of vehicles respectively. The common side view mirror is added with a turn signal lamp so as to indicate the direction. However, conventional turn signal lamps are generally disposed on a housing of the side view mirror. The housing is located on rear aide or lateral side of the mirror so that the turn signal lamp can only indicate a change in direction of front-side (forward). Thus the function of the turn signal lamp to indicate direction of turns is limited, without indicating left/right turns. Moreover, the plastic transparent housing of the turn signal lamp is exposed on housing of the side view mirror projecting outwards. Thus it is easy to get damaged and this brings users trouble to replace the side view mirror. Furthermore, while back up at night, it's difficult for drivers to see clearly at the rear wheels due to poor night vision. Once an auxiliary lamp for back-up is added on the side view mirror, it provides more light while reversing the cars. Therefore, there is a need to add an auxiliary lamp for indicating directions of turns or providing light for back-up on the side view mirror.

### SUMMARY OF THE INVENTION

It is therefore a primary object of the present invention to provide an auxiliary lamp composed by a light providing backup illumination on inner side of the side view mirror and a multi-directional turn-signal lamp with function of front-side, lateral-side and rear-side indications. The auxiliary lamp is disposed on bottom area of the side view mirror. The light providing backup illumination only works when the car lights and the reversing lamps acts synchronously while the multi-directional turn-signal lamp works synchronously with original car turn-signal lamps so as to make the side mirror have functions of both the backup illumination and directional indications. Therefore, the safety and convenience of vehicles while turning at night are improved. The performance and the added value are also increased.

It is another object of the present invention to provide an auxiliary lamp on a side view mirror for vehicles that combines the light providing backup illumination with the multi-directional turn-signal lamp into an integrated part that is disposed on bottom area of the side view mirror. Thus the integrated part occupies small space, has no influence on original function of the side view mirror and make the side view mirror become multifunctional. Therefore, drivers are willing to use or install the new device.

It is a further object of the present invention to provide an auxiliary lamp on a side view mirror for vehicles that has the multi-directional turn-signal lamp with function of front-side, lateral-side and rear-side indications. Thus the message of turning right/left is effectively delivered to the drivers in cars coming from front side, rear side or lateral side. The warning effect is obviously to the drivers in parallel vehicles toward the same direction. Thus the safety and convenience of vehicles while turning right/left are improved.

It is a further object of the present invention to provide an auxiliary lamp on a side view mirror for vehicles that is arranged on and integrated with the bottom surface of the side view mirror. Or the auxiliary lamp forms another structure that can be assembled on the bottom surface of the side view mirror without occupying too much space and influence original function of the side view mirror. The structure is simplified so that the manufacturing or assembling cost is reduced.

### BRIEF DESCRIPTION OF THE DRAWINGS

FIG. 1 is a perspective view of an embodiment in accordance with the present invention;

FIG. 2 is a side view of the embodiment in FIG. 1;

FIG. 3 is a partial cross-sectional view of a light providing backup illumination of the embodiment in FIG. 2;

FIG. 4 is a partial cross-sectional view of a multi-directional turn-signal lamp of the embodiment in FIG. 2;

FIG. 5 is a schematic drawing showing the light providing backup illumination of the present invention in usage;

FIG. 6 is a schematic drawing showing the multi-directional turn-signal lamp of the present invention in usage;

FIG. 7 is a schematic drawing showing an embodiment of the present invention with a power outlet;

FIG. 8 is a schematic drawing of another embodiment in accordance with the present invention;

FIG. 9 is a schematic explosive view of the embodiment in FIG. 8.

### DETAILED DESCRIPTION OF THE PREFERRED EMBODIMENT

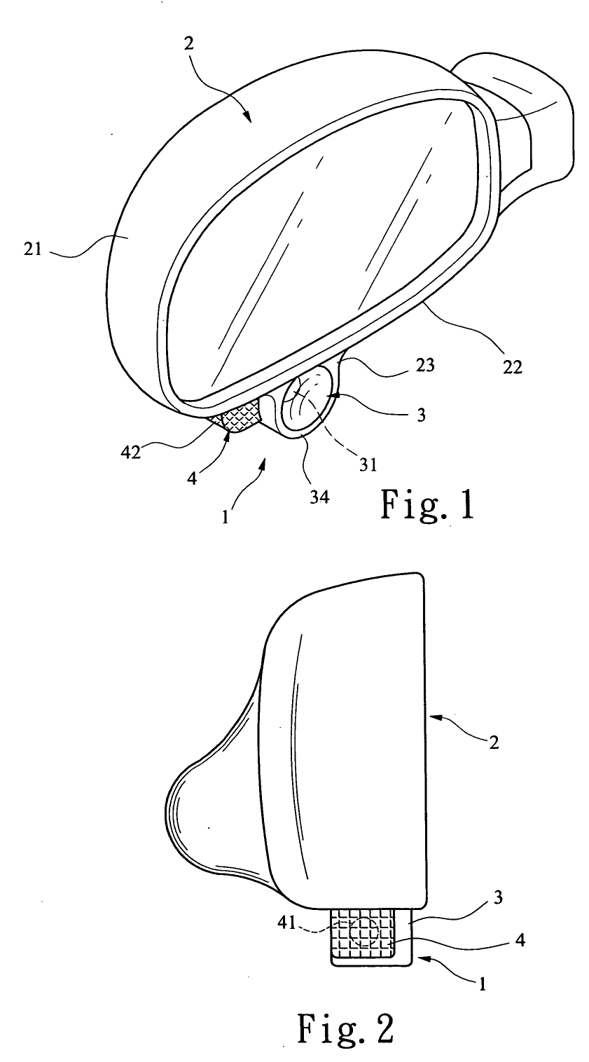

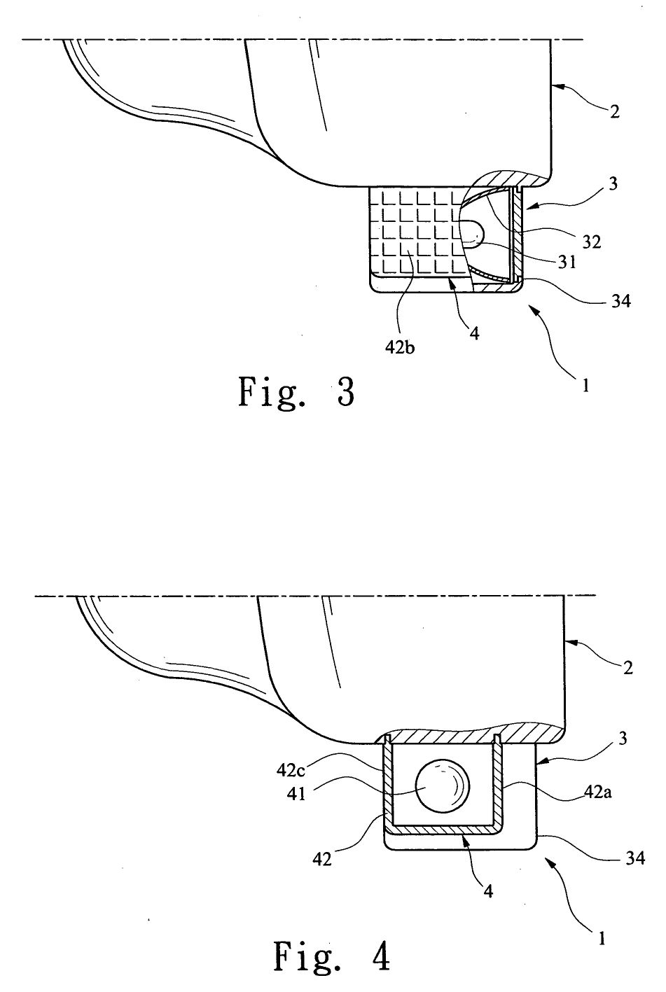

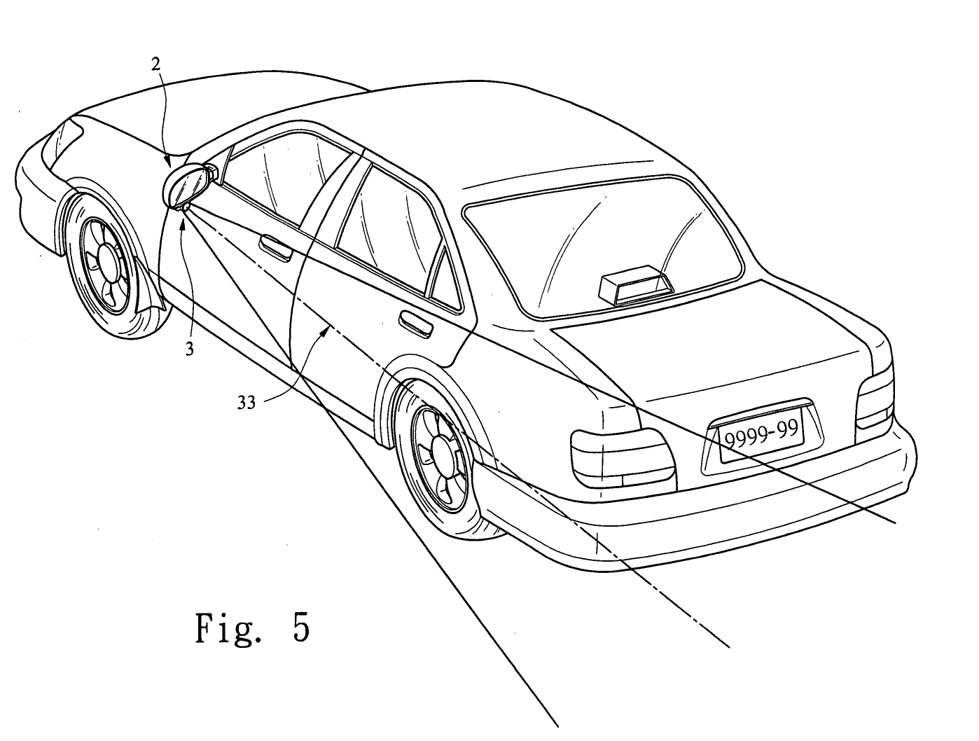

Refer from FIG. 1 to FIG. 4, an auxiliary lamp on a side view mirror for vehicles 1 in accordance with the present invention is disposed on bottom area of the side view mirror 2. The auxiliary lamp of a side view mirror 1 includes a light providing backup illumination 3 on inner side and a multidirectional turn-signal lamp 4 on outer side thereof. The arrangement of the light providing backup illumination 3 and the multidirectional turn-signal lamp 4 is preferred in parallel. The two parts are assembled and disposed inside an extending part 23 on bottom surface 22 of a housing 21 of the side view mirror 2. The extending part 23 is integrated with the side view mirror 2 and is located on the bottom surface 22 of the housing 21. Other parts related to the light providing backup illumination 3 and the multidirectional turn-signal lamp 4 such as wires or light sources are also mounted in the space inside the extending part 23. By the wires, the light providing backup illumination 3 and the multidirectional turn-signal lamp 4 are connected with electronic control devices of vehicles.

The light providing backup illumination 3 having a projective light source 31 and a corresponding light-gathering lampshade 32 is located on inner side of the multidirectional turn-signal lamp 4, near the window of vehicles. The central axis of the projection light from the projective light source 31 assembled with the light-gathering lampshade 32 is towards wheels on rear side of vehicles. The projective light source 31 only works when the car lights and the reversing lamps acts synchronously. That is once the car light and the reversing lamps are both on at night or revering in the dark, the projective light source 31 of the light providing backup illumination 3 acts synchronously, illuminates toward the wheels on rear side of the vehicles, as shown in FIG. Thus drivers' vision is improved to see tail of vehicles and the safety as well as convenience of reversing in the dark also increased. Moreover, the projective light source 31 and the light-gathering lampshade 32 are better disposed on the location with a certain distance from an opening of the light providing backup illumination 3 so that the projection light won't have negative effect on drivers' eyes. There is no limitation on size of the projective light source 31 once it generates enough intensity of illumination.

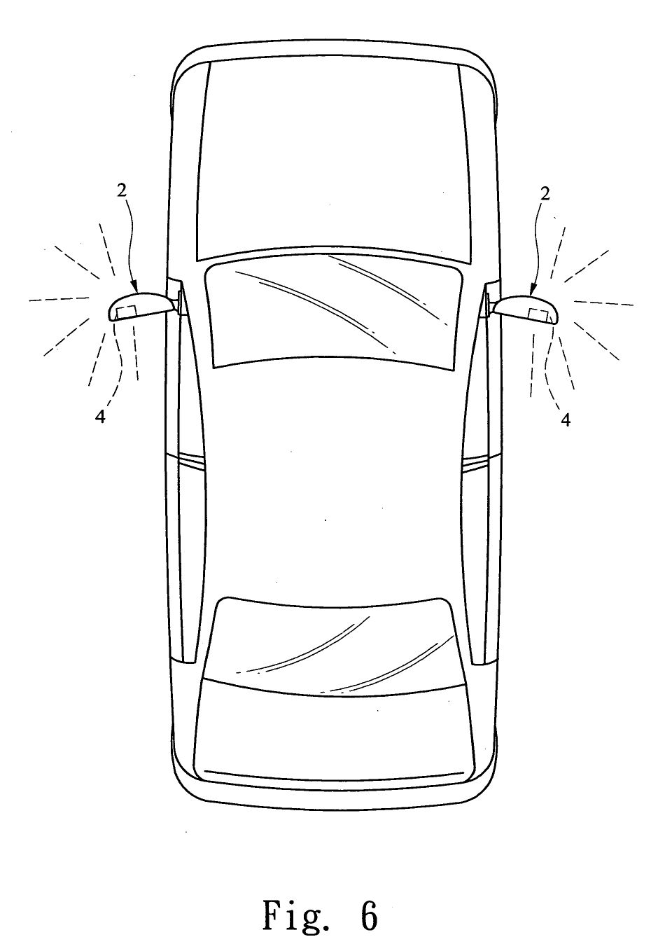

The multidirectional turn-signal lamp 4 having a light source with proper light intensity 41 and a transparent cover 42 is located on outer side of the light providing backup illumination 3, far away from the window of vehicles. The light source 41 works synchronously with original car turn-signal lamps. It can be light bulbs or LED (light emitting diode) lights. There is no limitation on number of the light source 41. It may be a single light such as light bulb that projects light towards three directions-front side, rear side and lateral side at the same time, as shown in FIG. 4. Or there is a light source 41 such as LED light on each of the directions—front side, rear side and lateral side (not shown in figure). The transparent cover 42 is covered outside the extending part 23 on the bottom surface 22 of the housing 21 and is an integrated cover. The transparent cover 42 includes at least three transparent areas 42a, 42b, and 42c—toward the front side, the lateral side and the rear side so that the light source 41 can illuminate light on three directions-front side, rear side and lateral side, as shown in FIG. 6. Thus the message of turning right/left is effectively delivered to the drivers in cars coming from front side, rear side or lateral side. The warning effect is obviously to the drivers in parallel vehicles toward the same direction. Thus the safety and convenience of vehicles while turning right/left are improved. Moreover, the transparent cover 42 had better arrange on the position on lateral side of the light providing backup illumination 3 to form a stepped surface with the opening 34 thereof so that the light providing backup illumination 3 is shielded between the transparent cover 42 and the drivers of vehicles and the light from the multidirectional turn-signal lamp 4 will not influence the operation of drivers to turn right/left.

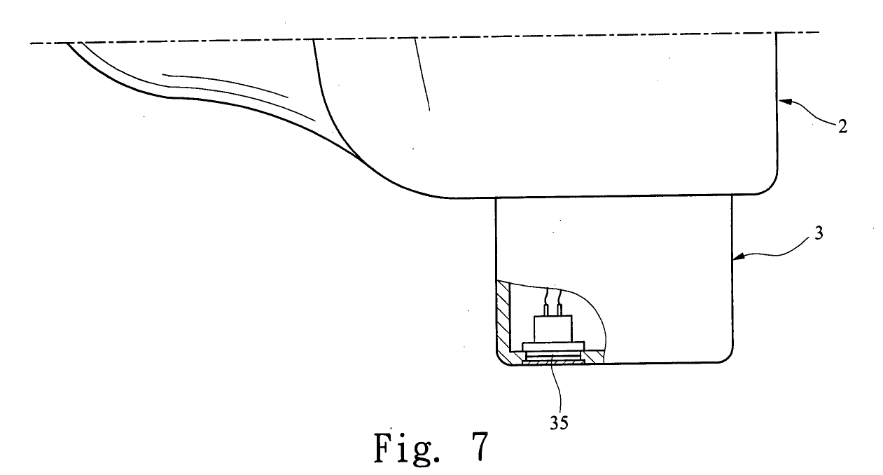

Furthermore, as shown in FIG. 7, a power outlet 35 connected to a power system of vehicles and controlled by a switch is installed under the housing 21 of the light providing backup illumination 3. In usage, the switch is turned on to form electrical connection so that the power outlet 35 can be used with personal electronics such as notebooks or small-size liquid crystal displays.

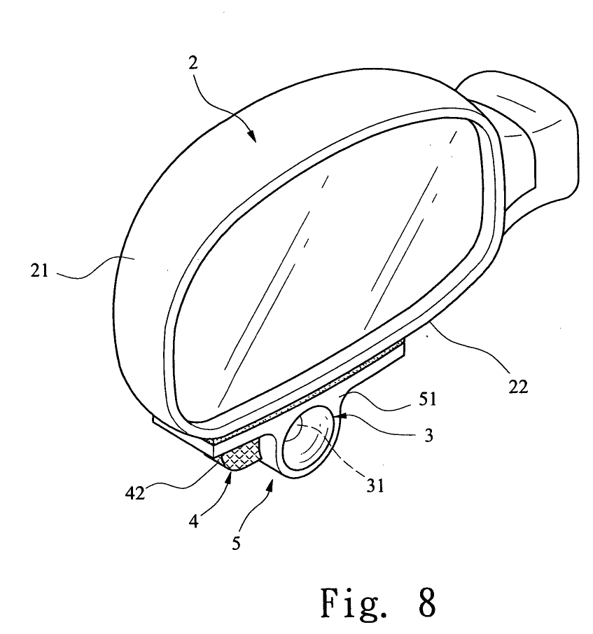

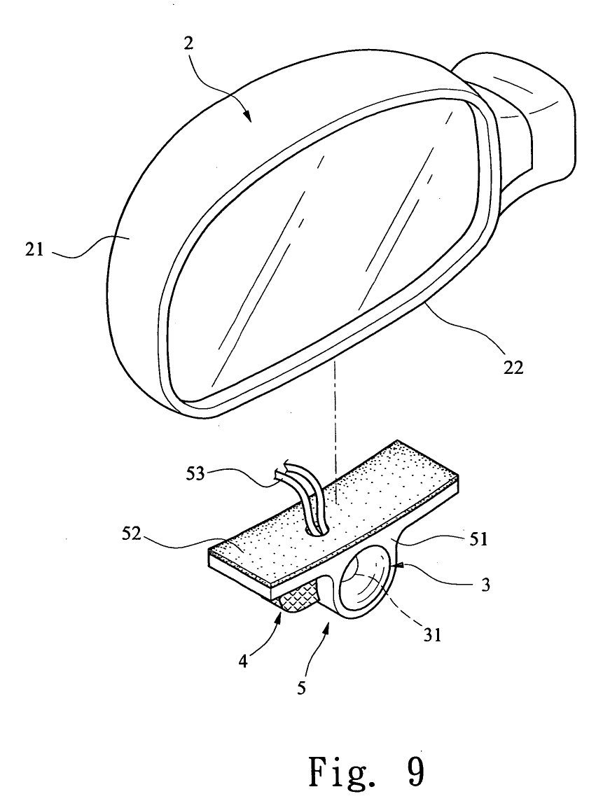

Refer to FIG. 8 & FIG. 9, the auxiliary lamp on a side view mirror for vehicles 1 in accordance with the present invention can be another structure 5. The structure 5 includes a housing 51, the light providing backup illumination 3 inside the housing 51, the multidirectional turn-signal lamp 4 on outer side, a fastening member 52 such as double side adhesive tape to attach the structure 5 easily on bottom surface 22 of the housing 21 of the side view mirror 2, and wires 53 that connects the device with a control device for control of the light providing backup illumination 3 and the multidirectional turn-signal lamp 4. The design of the fastening member 52 varies according to the style of the structure 5. The fastening member 52 can be waterproofing. Thus the structure 5 can be assembled easily on the bottom surface 22 of the housing of the side view mirror 2 according to users' needs. It won't occupy too much space and have no effect on function of the side view mirror 2. Therefore, drivers are willing to use or install the new device.

What is claimed is:

1. An auxiliary lamp on a side view mirror for vehicles disposed on bottom area of the side view mirror comprising a light providing backup illumination and a multidirectional turn-signal lamp; wherein the light providing backup illumination on inner side of the multidirectional turn-signal lamp having a projective light source and a light-gathering lampshade; a central axis of a projection light from the projective light source assembled with the light-gathering lampshade is towards wheels on rear side of vehicles and the projective light source only works when the car lights and the reversing lamps acts synchronously; the multidirectional turn-signal lamp on outer side of the light providing backup illumination having an inner light source and a transparent cover; the light source works synchronously with original car turn-signal lamps while the transparent cover includes at least three transparent areas on front side, lateral aide and rear side thereof so that light from the light source illuminates through the transparent areas.

2. The auxiliary lamp on the side view mirror for vehicles as claimed in claim 1, wherein the light providing backup illumination and the multidirectional turn-signal lamp are arranged inside an extending part on bottom surface of a housing of the side view mirror.

3. The auxiliary lamp on the side view mirror for vehicles as claimed in claim 1, wherein the light providing backup illumination and the multidirectional turn-signal lamp are preferred to be arranged in inner side and outer side parallel.

4. The auxiliary lamp on the side view mirror for vehicles as claimed in claim 2, wherein the light providing backup illumination and the multidirectional turn-signal lamp are preferred to be arranged in inner side and outer side parallel.

5. The auxiliary lamp on the side view mirror for vehicles as claimed in claim 1, wherein the projective light source of the multidirectional turn-signal lamp is disposed on the location with a certain distance from an opening of the back-up light.

6. The auxiliary lamp on the side view mirror for vehicles as claimed in claim 1, wherein the inner light source of the multidirectional turn-signal lamp is a light bulb or a light-emitting diode light.

7. The auxiliary lamp on the side view mirror for vehicles as claimed in claim 1, wherein there is no limitation on numbers of the inner light source of the multidirectional turn-signal lamp.

8. The auxiliary lamp on the side view mirror for vehicles as claimed in claim 5, wherein there is no limitation on numbers of the inner light source of the multidirectional turn-signal lamp.

9. The auxiliary lamp on the side view mirror for vehicles as claimed in claim 1, wherein the transparent cover had better arrange on the position on lateral side of the light providing backup illumination to form a stepped surface with the opening.

10. The auxiliary lamp on the side view mirror for vehicles as claimed in claim 1, wherein the auxiliary lamp is a structure that includes a housing, a light providing backup illumination on inner side of the housing, a multidirectional turn-signal lamp on outer side of the housing, a fastening member for fixing the structure on bottom surface of a housing of the side view mirror, and wires for connecting the structure with a electronic control device of vehicles.

11. The auxiliary lamp on the side view mirror for vehicles as claimed in claim 1, wherein the fastening member is waterproof.
